(19) United States
(12) Patent Application Publication
(10) Pub. No.: US 2025/0144996 A1
(43) Pub. Date: May 8, 2025

(54) VEHICLE

(71) Applicants: HYUNDAI MOTOR COMPANY, SEOUL (KR); KIA CORPORATION, SEOUL (KR)

(72) Inventors: Sang Wan Kim, Busan (KR); Min Yong Son, Seoul (KR); Kyung Ho Kim, Ansan-si (KR)

(21) Appl. No.: 18/627,050

(22) Filed: Apr. 4, 2024

(30) Foreign Application Priority Data
Nov. 6, 2023 (KR) 10-2023-0151995

(51) Int. Cl. B60K 11/02; B60H 1/00; B60R 16/08; H01M 10/613; H01M 10/625; H01M 10/6568

(52) U.S. Cl. CPC B60K 11/02; B60H 1/00278; H01M 10/613; H01M 10/625; H01M 10/6568; B60R 16/08; H01M 2220/20

(57) ABSTRACT

A vehicle includes a first region in which a reservoir, an air separator, and a pump are disposed, and a second region in which a chiller and a compressor are disposed The first and second regions are spaced apart from each other in a leftward and rightward direction.

### CROSS REFERENCE TO RELATED APPLICATIONS

This application claims priority to and the benefit of Korean Patent Application No. 10-2023-0151995 filed in the Korean Intellectual Property Office on Nov. 6, 2023, the entire contents of which are incorporated herein by reference.

### TECHNICAL FIELD

The present disclosure relates to a vehicle, and more particularly, to a vehicle equipped with a battery and a cooling means configured to cool the battery.

### BACKGROUND

An electric vehicle, which operates while converting electrical energy of a battery into kinetic energy, is equipped with components for cooling the battery as well as the battery. That is, the electric vehicle is equipped with a pipe line through which a cooling fluid circulates to cool the battery. In the pipe line, components, such as a reservoir for storing the cooling fluid, an air separator for separating air from the cooling fluid, and a pump for pumping the cooling fluid, are mounted.

However, because other components are mounted in the electric vehicle in addition to the above-mentioned components, a space in the vehicle, in which the battery and the components for cooling the battery may be disposed, is inevitably restrictive. Therefore, there is a need for a layout related to the arrangement of the components, which is different from that in an internal combustion engine vehicle, in order to effectively dispose the battery and the components for cooling the battery in the electric vehicle.

### SUMMARY

The present disclosure has been made in an effort to provide a novel layout, which is related to components for cooling a battery in an electric vehicle, and to optimize the layout related to cooling lines and cooling components in the electric vehicle.

The present disclosure has also been made in an effort to improve the overall durability of an electric vehicle by preventing a leak of a coolant caused by an impact from the outside of the vehicle.

In order to achieve the above-mentioned objects, one aspect of the present disclosure provides a vehicle including a reservoir having a space in which a cooling fluid is stored, an air separator connected to the reservoir and configured to separate air from the cooling fluid supplied from the reservoir, a pump connected to the air separator and configured to pump the cooling fluid supplied from the air separator, a chiller connected to the pump and configured to cool the cooling fluid supplied from the pump, and a compressor connected to the chiller and configured to supply the chiller with a refrigerant that exchanges heat with the cooling fluid, in which a region A1, in which the reservoir, the air separator, and the pump are disposed, and a region A2, in which the chiller and the compressor are disposed, are spaced apart from each other in a leftward/rightward direction W.

The region A1, in which the reservoir, the air separator, and the pump are disposed, and the region A2, in which the chiller and the compressor are disposed, may be spaced apart from each other in the leftward/rightward direction W with a center of the vehicle interposed therebetween.

The air separator may be spaced apart downward from the reservoir.

The region A1, in which the reservoir, the air separator, and the pump are disposed, may be provided in a left region of the vehicle, and the region A2, in which the chiller and the compressor are disposed, may be provided in a right region of the vehicle.

The vehicle may further include: a transverse pipe configured to connect the pump and the chiller and extending in the leftward/rightward direction W, and a cross member that is a part of a vehicle body provided in the vehicle and extends in the leftward/rightward direction W, in which the transverse pipe is fixedly coupled to the cross member.

The vehicle may further include a clip member coupled to the transverse pipe, in which the cross member has a recess portion having a shape, which corresponds to the clip member, and having a recessed shape, and the clip member is inserted into the recess portion.

The clip member may include a first clip member provided on the transverse pipe and disposed to be close to the left region of the vehicle, and a second clip member provided on the transverse pipe and disposed to be close to the right region of the vehicle.

The transverse pipe may have a curved section provided in a partial region thereof.

The air separator may be fastened to one point on a vehicle body of the vehicle.

The vehicle may further include an air separator-pump connection pipe configured to connect the air separator and the pump, in which at least a part of the air separator-pump connection pipe is disposed in an internal space defined by a front side member, a front apron, and a wheel guard of a vehicle body of the vehicle.

The pump may be fastened to a fender apron of a vehicle body of the vehicle.

The pump may be fastened to two points on a fender apron of a vehicle body of the vehicle.

At least a part of the transverse pipe may be disposed in an internal space defined by a fender apron, the cross member, and a wheel guard of the vehicle body of the vehicle.

The vehicle may further include a battery system assembly (BSA) connected to the chiller so that the cooling fluid discharged from the chiller is introduced into the BSA, a chiller-BSA connection pipe configured to connect the chiller and the BSA, and an interference member provided in a route along which the chiller-BSA connection pipe extends, in which the chiller-BSA connection pipe is disposed to surround at least a partial region of the interference member so as to bypass the interference member.

The interference member may include a steering gear, a drive shaft, and a flywheel, and the chiller-BSA connection pipe may be disposed to sequentially bypass the steering gear, the driver shaft, and the flywheel.

The vehicle may further include coupling members configured to fix the chiller-BSA connection pipe to a vehicle body of the vehicle, in which the coupling members include a first coupling member coupled to a region of the chiller-BSA connection pipe that is opposite to a direction in which the steering gear faces the driver shaft, a second coupling member coupled to a region of the chiller-BSA connection pipe disposed between the driver shaft and the flywheel, and a third coupling member coupled to a region of the chiller-BSA connection pipe that is opposite to a direction in which the flywheel faces the drive shaft.

A region of the air separator-pump connection pipe, which is connected to the air separator, may be disposed in an internal space defined by the front side member, the front apron, and the wheel guard.

A region of the transverse pipe, which is connected to the pump, may be disposed in an internal space defined by the fender apron, the cross member, and the wheel guard.

According to the present disclosure, it is possible to provide the novel layout, which is related to the components for cooling the battery in the electric vehicle, and to optimize the layout related to the cooling lines and the cooling components in the electric vehicle.

In addition, according to the present disclosure, it is possible to improve the overall durability of the electric vehicle by preventing a leak of the coolant caused by an impact from the outside of the vehicle.

### BRIEF DESCRIPTION OF THE FIGURES

FIG. 1 is a view illustrating a part of a structure of a vehicle according to the present disclosure.

FIG. 2 is an enlarged view illustrating a structure in which a reservoir, an air separator, and a pump provided in the vehicle according to the present disclosure are disposed.

FIG. 3 is an enlarged view illustrating the air separator and peripheral components thereof provided in the vehicle according to the present disclosure.

FIG. 4 is an enlarged view illustrating the pump and peripheral components thereof provided in the vehicle according to the present disclosure.

FIG. 5 is a view illustrating a transverse pipe and peripheral components thereof provided in the vehicle according to the present disclosure when viewed from a front side of the vehicle.

FIG. 6 is a view for explaining an example of a structure in which the transverse pipe provided in the vehicle according to the present disclosure is coupled to a cross member of a vehicle body.

FIG. 7 is an enlarged view illustrating a structure in which a chiller and a compressor provided in the vehicle according to the present disclosure are disposed.

FIG. 8 is an enlarged view illustrating a chiller-BSA connection pipe and peripheral components thereof provided in the vehicle according to the present disclosure.

### DETAILED DESCRIPTION

Hereinafter, a vehicle according to the present disclosure will be described with reference to the drawings.

A vehicle according to the present disclosure may be applied to a vehicle equipped with a battery. More specifically, the vehicle according to the present disclosure may be a vehicle that operates wheels by using electrical energy as a power source. For example, the vehicle according to the present disclosure may be an electric vehicle, a hybrid vehicle, or a hydrogen fuel cell vehicle.

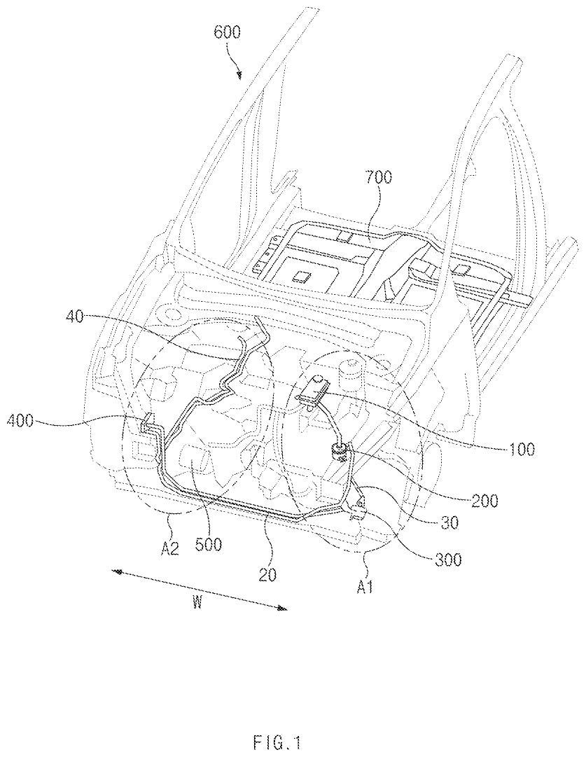

FIG. 1 is a view illustrating a part of a structure of a vehicle according to the present disclosure.

With reference to FIG. 1, a vehicle 10 according to the present disclosure may include a reservoir 100 having a space in which a cooling fluid is stored. As described below, the vehicle 10 according to the present disclosure may include a battery system assembly (BSA) including a battery. The cooling fluid may serve to cool the BSA. In case that the BSA is cooled in a water-cooled manner, the cooling fluid may be a low-conductivity coolant with low thermal conductivity.

In addition, the vehicle 10 according to the present disclosure may include an air separator 200 connected to the reservoir 100 and configured to separate air from the cooling fluid supplied from the reservoir 100. The air separator 200 may separate air from the cooling fluid in various ways. For example, the air separator 200 may separate air from the cooling fluid by generating a centrifugal force in the cooling fluid while decreasing a flow velocity of the cooling fluid to be supplied to the air separator 200. For example, when a fluid containing the air and the cooling fluid in the air separator 200 receives a centrifugal force as a flow velocity of the fluid is decreased by an internal structure or the like of the air separator 200, a pressure of a central portion of the fluid decreases, and the solubility of the air into the cooling fluid decreases, such that the air may be separated from the cooling fluid. However, the air separator 200 is not limited to the above-mentioned description, and the air separator 200 may separate air from the cooling fluid in various ways. Meanwhile, the reservoir 100 and the air separator 200 may be connected to each other through a pipe. Therefore, the cooling fluid stored in the reservoir 100 may be introduced into the air separator 200 through the pipe.

With reference to FIG. 1, the vehicle 10 according to the present disclosure may include a pump 300 connected to the air separator 200 and configured to pump the cooling fluid supplied from the air separator 200. The pump 300 may be configured to provide kinetic energy to the cooling fluid by pumping the cooling fluid, thereby allowing the cooling fluid to circulate more smoothly. For example, the pump 300 may be an electric water pump (EWP). Meanwhile, the vehicle 10 according to the present disclosure may further include an air separator-pump connection pipe 30 configured to connect the air separator 200 and the pump 300. Therefore, the cooling fluid, from which the air is separated by the air separator 200, may be supplied to the pump 300 through the air separator-pump connection pipe 30.

The vehicle 10 according to the present disclosure may further include a chiller 400 connected to the pump 300 and configured to cool the cooling fluid supplied from the pump 300. More specifically, not only the cooling fluid for cooling the battery of the vehicle 10 may be introduced into the chiller 400, but also a separate refrigerant, which is different from the cooling fluid, may also be introduced into the chiller 400, and the cooling fluid and the refrigerant may exchange heat with each other in the chiller 400. In this case, because the refrigerant has a relatively lower temperature than the cooling fluid, the cooling fluid may be cooled in the chiller 400 and then discharged.

Meanwhile, the vehicle 10 according to the present disclosure may further include a pipe configured to connect the pump 300 and the chiller 400. The above-mentioned pipe may extend in a leftward/rightward direction W of the vehicle 10. In the present specification, the above-mentioned pipe is referred to as a transverse pipe 20. The transverse pipe 20 will be described below more specifically.

With reference to FIG. 1, the vehicle may further include a compressor 500 connected to the chiller 400 and configured to supply the chiller 400 with the refrigerant that exchanges heat with the cooling fluid. More specifically, the refrigerant, which is pressurized by the compressor 500 and then discharged, may decrease in temperature while passing through a radiator (not illustrated) and then be supplied to the chiller 400.

Meanwhile, the vehicle 10 according to the present disclosure may further include a pipe configured to connect the chiller 400 and the compressor 500. Therefore, the refrigerant, which is compressed in the compressor 500, may be supplied to the chiller 400 through the above-mentioned pipe.

Meanwhile, according to the present disclosure, a region A1, in which the reservoir 100, the air separator 200, and the pump 300 are disposed, may be spaced apart from a region A2 in which the chiller 400 and the compressor 500 are disposed. More specifically, as illustrated in FIG. 1, the region A1, in which the reservoir 100, the air separator 200, and the pump 300 are disposed, and the region A2, in which the chiller 400 and the compressor 500 are disposed, may be spaced apart from each other in the leftward/rightward direction W of the vehicle 10. More particularly, the region A1, in which the reservoir 100, the air separator 200, and the pump 300 are disposed, and the region A2, in which the chiller 400 and the compressor 500 are disposed, may be spaced apart from each other in the leftward/rightward direction W with a center of the vehicle 10 interposed therebetween. That is, according to the present disclosure, the components and pipes for cooling the battery in the vehicle 10 are concentratedly disposed in a partial region in the vehicle 10, which makes it possible to minimize a space in the vehicle 10 occupied by the components for cooling the battery. For example, in FIG. 1, the region A1, in which the reservoir 100, the air separator 200, and the pump 300 are disposed, may be provided in a left region of the vehicle 10, and the region A2, in which the chiller 400 and the compressor 500 are disposed, may be provided in a right region of the vehicle. Meanwhile, the configuration in which the region A1 and the region A2 are spaced apart from each other may be understood as a configuration in which the region A1 and the region A2 do not overlap each other.

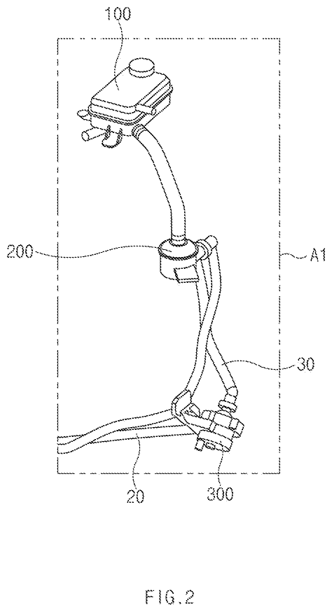

FIG. 2 is an enlarged view illustrating a structure in which the reservoir, the air separator, and the pump provided in the vehicle according to the present disclosure are disposed.

With reference to FIG. 2, the air separator 200 may be spaced apart downward from the reservoir 100. In this case, the air, which is separated from the cooling fluid by the air separator 200, may be smoothly discharged to a location above the air separator 200. Meanwhile, FIG. 2 illustrates an example in which the pump 300 is spaced apart downward from the air separator 200.

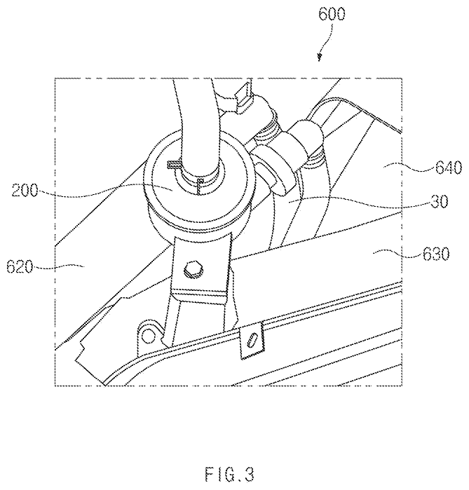

FIG. 3 is an enlarged view illustrating the air separator and peripheral components thereof provided in the vehicle according to the present disclosure.

With reference to FIGS. 1 to 3, at least a part of the air separator-pump connection pipe 30 may be disposed in an internal space defined by some components of a vehicle body 600 of the vehicle 10.

More specifically, at least a part of the air separator-pump connection pipe 30 may be disposed in the internal space defined by a front side member 620, a front apron 630, and a wheel guard 640 of the vehicle body 600 of the vehicle 10. More specifically, as illustrated in FIG. 3, a region of the air separator-pump connection pipe 30, which is connected to the air separator 200, may be disposed in the internal space defined by the front side member 620, the front apron 630, and the wheel guard 640. This is to prevent damage to the pipe or a leak of the cooling fluid caused by damage to the pipe caused by an external impact in the region of the air separator-pump connection pipe 30 that is connected to the air separator 200 and is relatively vulnerable to the external impact.

Meanwhile, the air separator 200 may be fastened to one point on the vehicle body 600 of the vehicle 10. For example, as illustrated in FIG. 3, the air separator 200 may be fastened to one point in a region of the vehicle body 600 that protrudes upward from the front apron 630.

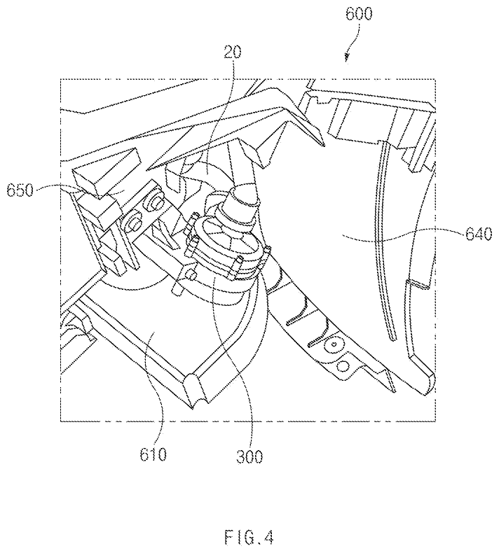

FIG. 4 is an enlarged view illustrating the pump and peripheral components thereof provided in the vehicle according to the present disclosure.

Unlike the air separator 200, the pump 300 may be fastened to two points on the vehicle body 600. This is because a more secure fastening structure is required for the pump 300 because the pump 300 is relatively heavier in weight than the air separator 200. For example, as illustrated in FIG. 4, the pump 300 may be fastened to a fender apron 650 of the vehicle body 600 of the vehicle 10. More particularly, the pump 300 may be fastened to two points on the fender apron 650 of the vehicle body 600.

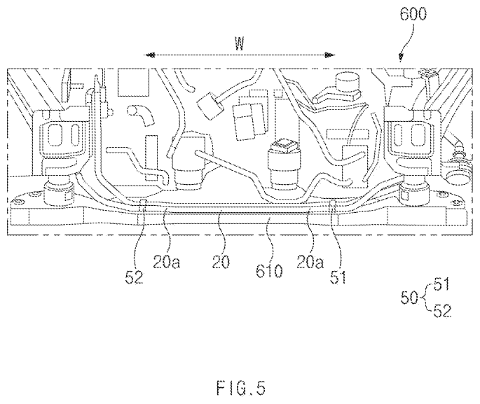

FIG. 5 is a view illustrating the transverse pipe and peripheral components thereof provided in the vehicle according to the present disclosure when viewed from a front side of the vehicle.

With reference to FIG. 5, the vehicle 10 according to the present disclosure may further include a cross member 610 that is a part of the vehicle body 600 and extends in the leftward/rightward direction W. The cross member 610 may be positioned in a foremost region of the vehicle body 600.

In this case, the transverse pipe 20 may be fixedly coupled to the cross member 610. FIG. 5 illustrates an example in which the transverse pipe 20 is fixedly coupled to an upper region of the cross member 610.

Meanwhile, with reference to FIGS. 4 and 5, in addition, at least a part of the transverse pipe 20 may be disposed in an internal space defined by some components of the vehicle body 600 of the vehicle 10.

More specifically, as illustrated in FIGS. 4 and 5, a region of the transverse pipe 20, which is connected to the pump 300, may be disposed in an internal space defined by the fender apron 650, the cross member 610, and the wheel guard 640. This is to prevent damage to the pipe or a leak of the cooling fluid caused by damage to the pipe caused by an external impact in the region of the transverse pipe 20 that is connected to the pump 300 and is relatively vulnerable to the external impact.

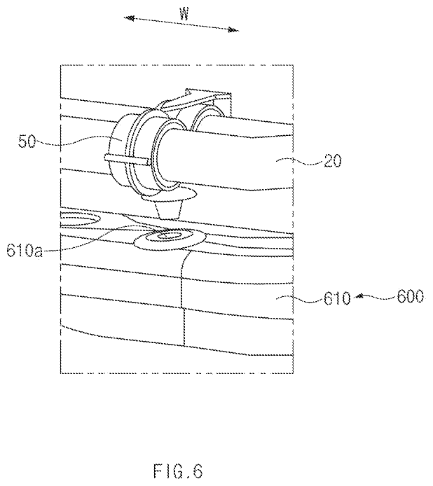

FIG. 6 is a view for explaining an example of a structure in which the transverse pipe provided in the vehicle according to the present disclosure is coupled to the cross member of the vehicle body.

With reference to FIG. 6, in order to fix and couple the transverse pipe 20 to the cross member 610, the vehicle 10 may further include clip members 50 coupled to the transverse pipe 20, and the cross member 610 may have a recess portion 610a having a shape, which corresponds to the clip member 50, and having a recessed shape. In this case, the clip member 50 may be inserted into the recess portion 610a.

More particularly, the clip members 50 may be provided as a plurality of clip members 50, and the transverse pipe 20 may be fixedly coupled to a plurality of regions of the cross member 610 by the plurality of clip members 50. For example, the clip members 50 may include a first clip member 51 provided on the transverse pipe 20 and disposed to be close to the left region of the vehicle 10, and a second clip member 52 provided on the transverse pipe 20 and disposed to be close to the right region of the vehicle 10.

Meanwhile, with reference to FIG. 5, the transverse pipe 20 may extend approximately in the leftward/rightward direction W of the vehicle 10 and have a curved section 20a in a partial region thereof. The curved section 20a may be configured to minimize the sway of the transverse pipe 20 when vibration or impact is applied to the transverse pipe 20 in an upward/downward direction while the vehicle 10 travels, thereby improving the rigidity of the transverse pipe 20. For example, as illustrated in FIG. 5, a height of the transverse pipe 20 in the upward/downward direction may vary based on a boundary of the curved section 20a of the transverse pipe 20. In addition, the curved section 20a may be provided in a region between the first clip member 51 and the second clip member 52.

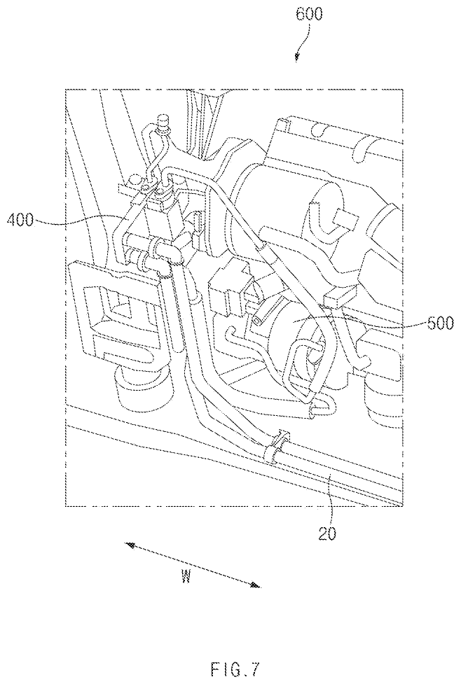

FIG. 7 is an enlarged view illustrating a structure in which the chiller and the compressor provided in the vehicle according to the present disclosure are disposed.

As illustrated in FIG. 7, the chiller 400 and the compressor 500 may be positioned adjacent to each other. For example, the compressor 500 may be positioned below the chiller 400. However, the compressor 500 and the chiller 400 only need to be disposed adjacent to each other, and the relative positional relationship in the upward/downward direction is not limited by the above-mentioned description.

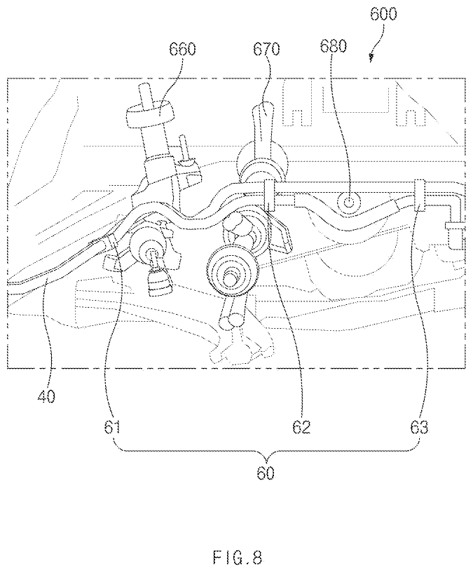

FIG. 8 is an enlarged view illustrating a chiller-BSA connection pipe and peripheral components thereof provided in the vehicle according to the present disclosure.

Meanwhile, the vehicle 10 may further include a battery system assembly (BSA) 700 connected to the chiller 400 so that the cooling fluid discharged from the chiller 400 is introduced into the BSA 700. The BSA 700 may include a battery mounted in the vehicle 10. In addition, the vehicle 10 may further include a chiller-BSA connection pipe 40 configured to connect the chiller 400 and the BSA 700. Therefore, the cooling fluid, which is cooled by the chiller 400 and discharged, may be supplied to the BSA 700 through the chiller-BSA connection pipe 40.

In this case, during a process in which the chiller-BSA connection pipe 40 extends from the chiller 400 to the BSA 700, the chiller-BSA connection pipe 40 may include a section that bypasses the other components in the vehicle 10. More specifically, as illustrated in FIG. 8, the vehicle 10 may further include interference members provided in a route along which the chiller-BSA connection pipe 40 extends. The chiller-BSA connection pipe 40 may be disposed to surround at least a partial region for each of the interference members in order to bypass the interference members.

For example, the interference members may include a steering gear 660, a driver shaft 670, and a flywheel 680, and the chiller-BSA connection pipe 40 may be disposed to sequentially bypass the steering gear 660, the driver shaft 670, and the flywheel 680. Therefore, the chiller-BSA connection pipe 40 may include curved sections configured to respectively surround a partial region of the steering gear 660, a partial region of the driver shaft 670, and a partial region of the flywheel 680.

With reference to FIG. 8, the vehicle 10 may further include coupling members 60 configured to fix the chiller-BSA connection pipe 40 to the vehicle body 600 of the vehicle 10.

More specifically, the coupling members 60 may include a first coupling member 61 coupled to a region of the chiller-BSA connection pipe 40 that is opposite to a direction in which the steering gear 660 faces the driver shaft 670, a second coupling member 62 coupled to a region of the chiller-BSA connection pipe 40 disposed between the driver shaft 670 and the flywheel 680, and a third coupling member 63 coupled to a region of the chiller-BSA connection pipe 40 that is opposite to a direction in which the flywheel 680 faces the drive shaft 670. The coupling members 60, 61, 62, and 63 may be clip members similar to the clip members denoted by reference numerals 50, 51, and 52. However, the present disclosure is not limited thereto, and the coupling members 60, 61, 62, and 63 may be bolt members or screw members.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

1. A vehicle comprising:
a reservoir having a space in which a cooling fluid is stored;
an air separator connected to the reservoir and configured to separate air from the cooling fluid supplied from the reservoir;
a pump connected to the air separator and configured to pump the cooling fluid supplied from the air separator;
a chiller connected to the pump and configured to cool the cooling fluid supplied from the pump; and
a compressor connected to the chiller and configured to supply the chiller with a refrigerant that exchanges heat with the cooling fluid;
wherein a first region includes the reservoir, the air separator, and the pump, and a second region includes the chiller and the compressor, the first region being spaced apart from the second region in a leftward and rightward direction.

2. The vehicle of claim 1, wherein the vehicle is positioned between the first region and the second region.

3. The vehicle of claim 1, wherein the air separator is spaced apart downward from the reservoir.

4. The vehicle of claim 1, wherein the first region is positioned in a left region of the vehicle, and the second region is positioned in a right region of the vehicle.

5. The vehicle of claim 4, further comprising:
a transverse pipe configured to connect the pump and the chiller, and extending in the leftward and rightward direction; and
a cross member part of a vehicle body provided in the vehicle and extending in the leftward and rightward direction,
wherein the transverse pipe is fixedly coupled to the cross member.

6. The vehicle of claim 5, further comprising:
a clip member coupled to the transverse pipe,
wherein the cross member has a recess portion having a shape corresponding to the clip member, the shape being recessed, and the clip member being configured to be inserted into the recess portion.

7. The vehicle of claim 6, wherein the clip member comprises:
a first clip member provided on the transverse pipe and positioned close to the left region of the vehicle; and
a second clip member provided on the transverse pipe and positioned close to the right region of the vehicle.

8. The vehicle of claim 5, wherein the transverse pipe has a curved section provided in a partial region.

9. The vehicle of claim 1, wherein the air separator is fastened to one point on a body of the vehicle.

10. The vehicle of claim 1, further comprising:
an air separator-pump connection pipe configured to connect the air separator and the pump;
wherein at least a part of the air separator-pump connection pipe is positioned in an internal space defined by a front side member, a front apron, and a wheel guard of a body of the vehicle.

11. The vehicle of claim 1, wherein the pump is fastened to a fender apron of a body of the vehicle.

12. The vehicle of claim 1, wherein the pump is fastened to two points on a fender apron of a body of the vehicle.

13. The vehicle of claim 5, wherein at least a part of the transverse pipe is positioned in an internal space defined by a fender apron, the cross member, and a wheel guard of a body of the vehicle.

14. The vehicle of claim 1, further comprising:
a battery system assembly (BSA) connected to the chiller so the cooling fluid discharged from the chiller is introduced into the BSA;
a chiller-BSA connection pipe configured to connect the chiller and the BSA; and
an interference member positioned in a route along which the chiller-BSA connection pipe extends;
wherein the chiller-BSA connection pipe surrounds at least a partial region of the interference member to bypass the interference member.

15. The vehicle of claim 14, wherein the interference member comprises a steering gear, a drive shaft, and a flywheel, and the chiller-BSA connection pipe is positioned to sequentially bypass the steering gear, the driver shaft, and the flywheel.

16. The vehicle of claim 15, further comprising:
a plurality of coupling members configured to fix the chiller-BSA connection pipe to a body of the vehicle;
wherein the plurality of coupling members comprise:
a first coupling member coupled to a region of the chiller-BSA connection pipe that is opposite to a direction in which the steering gear faces the driver shaft;
a second coupling member coupled to a region of the chiller-BSA connection pipe positioned between the driver shaft and the flywheel; and
a third coupling member coupled to a region of the chiller-BSA connection pipe that is opposite to a direction in which the flywheel faces the drive shaft.

17. The vehicle of claim 10, wherein a region of the air separator-pump connection pipe, which is connected to the air separator, is positioned in an internal space defined by the front side member, the front apron, and the wheel guard.

18. The vehicle of claim 13, wherein a region of the transverse pipe, which is connected to the pump, is positioned in an internal space defined by the fender apron, the cross member, and the wheel guard.
